(19) United States
(12) Patent Application Publication
(10) Pub. No.: US 2026/0313453 A1
(43) Pub. Date: Oct. 8, 2026

(54) SUPPORT FOR RESTRICTED PDU SESSION TRANSFER BETWEEN SLICES

(71) Applicant: Telefonaktiebolaget LM Ericsson (publ), Stockholm (SE)

(72) Inventors: George Foti, Dollard des Ormeaux, Québec (CA); Peter Hedman, Helsingborg (SE)

(21) Appl. No.: 19/481,435

(22) PCT Filed: May 1, 2024
(86) PCT No.: PCT/IB2024/054220

§ 371 Date: Nov. 4, 2025

Related U.S. Application Data
(60) Provisional application No. 63/501,188, filed on May 10, 2023.

(51) Int. Cl. H04W 28/02; H04W 60/00

(52) U.S. Cl. CPC H04W 28/0289; H04W 60/00

(57) ABSTRACT

Systems and methods are disclosed for restricted transfer of User Equipments (UEs) and/or sessions between network slices. In one embodiment, a method performed by a network node comprises detecting that a network slice is congested and sending, to a second network node, congestion information for the network slice, wherein the congestion information comprises information that indicates that the network slice is to be replaced with an alternative network slice due to congestion for (a) an amount of UEs or (b) new UEs registering to the network slice, or both (a) and (b). In this manner, dynamic load balancing between a network slice and an associated alternative network slice in case of congestion in the network slice can be provided.

### RELATED APPLICATIONS

This application claims the benefit of provisional patent application Ser. No. 63/501,188, filed May 10, 2023, the disclosure of which is hereby incorporated herein by reference in its entirety.

### TECHNICAL FIELD

The present disclosure relates to a cellular communications system and, more specifically, to transfer of User Equipments (UEs) and/or sessions from one network slice to another network slice, e.g., due to congestion.

### BACKGROUND

There are several cases specified in 3^{rd} Generation Partnership Project (3GPP) Technical Specification (TS) 23.501 (by 3GPP TS 23.501 Change Request (CR) in S2-2303882) for the Access and Mobility Management Function (AMF) to initiate Protocol Data Unit (PDU) session transfers from one Single Network Slice Selection Assistance Information (S-NSSAI) to another S-NSSAI (i.e., from one network slice to another network slice). For example, if a network slice becomes unavailable or congested (e.g., based on Operations, Administration, and Maintenance (OAM) or Network Data Analytics Function (NWDAF) analytics output), then the Network Slice Selection Function (NSSF) informs AMFs through network slice availability notification about the impacted S-NSSAI. The notification may include an Alternative S-NSSAI which can be used by the AMF to replace the S-NSSAI. The NSSF notifies the AMF when the S-NSSAI is available again.

All solutions today assume a complete transfer of all PDU sessions from the impacted S-NSSAI to the Alternative S-NSSAI.

### SUMMARY

Systems and methods are disclosed for restricted transfer of User Equipments (UEs) and/or sessions between network slices. In one embodiment, a method performed by a network node comprises detecting that a network slice is congested and sending, to a second network node, congestion information for the network slice, wherein the congestion information comprises information that indicates that the network slice is to be replaced with an alternative network slice due to congestion for (a) an amount of UEs or (b) new UEs registering to the network slice, or both (a) and (b). In this manner, dynamic load balancing between a network slice and an associated alternative network slice in case of congestion in the network slice can be provided.

In one embodiment, the congestion information comprises information that indicates that the network slice is congested.

In one embodiment, the congestion information comprises information that indicates that the network slice is to be replaced with the alternative network slice due to congestion for an amount of UEs.

In one embodiment, the amount of UEs is a percentage of UEs. In another embodiment, the amount of UEs is an amount of new UEs requesting to be registered with the network slice. In another embodiment, the amount of UEs is an amount of existing UEs registered with the network slice. In another embodiment, the amount of UEs comprises an amount of existing and new UEs registered or requesting to be registered with the network slice.

In one embodiment, the amount of UEs is a function of a congestion level of the network slice.

In one embodiment, the congestion information comprises information that indicates that the network slice is to be replaced with the alternative network slice due to congestion for new UEs.

In one embodiment, the congestion information further comprises any one or more of the following: information that indicates that replacement is desired or requested for a specific UE or a specific set of UEs only, information that indicates whether replacement is desired or requested for only new UE requests or also for already registered UEs, and congestion level of the network slice.

In one embodiment, the congestion information further comprises the information that indicates that replacement is desired or requested for only new UE requests or also for already registered UEs, wherein already registered UEs comprise one or more UEs that are registered with the network slice within one or more established sessions with the network slice and/or one or more UEs that are registered with the network slice but without any established session or without any activated user plane for a session(s) for the network slice. In one embodiment, the sessions are Protocol Data Unit (PDU) sessions.

In one embodiment, the network node is a network node implementing a Network Slice Selection Function (NSSF). In another embodiment, the network node is a network node implementing an Operations, Administration, and Maintenance (OAM) node. In another embodiment, the network node is a network node implementing a Policy and Control Function (PCF) or Network Data Analytics Function, NWDAF.

In one embodiment, the second network node is an Access and Mobility Management Function (AMF).

In one embodiment, sending the congestion information for the network slice comprises sending a Network Slice Availability Notification comprising the congestion information to the second network node.

In one embodiment, the method further comprises sending, to the second network node, a trigger to stop replacement of the network slice with the alternative network slice.

In one embodiment, the method further comprises determining that the network slice is no longer congested and, in response thereto, sending, to the second network node, a trigger to stop replacement of the network slice with the alternative network slice.

In one embodiment, the method further comprises determining that the network slice is no longer congested and, responsive to determining that the network slice is no longer congested, sending, to the second network node, notification that triggers the second network node (200) to stop replacement of the network slice with the alternative network slice.

In one embodiment, the method further comprises determining that the network slice is no longer congested and, responsive to determining that the network slice is no longer congested, sending, to the second network node, notification that triggers the second network node to stop replacement of the network slice with the alternative network slice and move one or more UEs from the alternative network slice to the network slice.

Corresponding embodiments of a network node are also disclosed. In one embodiment, a network node is adapted to detect that a network slice is congested and send, to a second network node, congestion information for the network slice, wherein the congestion information comprises information that indicates that the network slice is to be replaced with an alternative network slice due to congestion for (a) an amount of UEs or (b) new UEs registering to the network slice, or both (a) and (b).

In one embodiment, a network node comprises processing circuitry configured to cause the network node to detect that a network slice is congested and send, to a second network node, congestion information for the network slice, wherein the congestion information comprises information that indicates that the network slice is to be replaced with an alternative network slice due to congestion for (a) an amount of UEs or (b) new UEs registering to the network slice, or both (a) and (b).

Embodiments of a method performed by an AMF are also disclosed. In one embodiment, a method performed by an AMF in a core network of a cellular communications system comprises determining that a network slice is to be replaced with an alternative network slice due to congestion in the network slice for (a) an amount of UEs or (b) new UEs registering to the network slice, or both (a) and (b), and replacing the network slice with the alternative network slice for (a) the amount of UEs or (b) new UEs registering to the network slice, or both (a) and (b).

In one embodiment, determining that the network slice is to be replaced with the alternative network slice due to congestion in the network slice comprises receiving congestion information for the network slice from another network node.

In one embodiment, the congestion information comprises information that indicates that the network slice is congested.

In one embodiment, the congestion information comprises information that indicates that the network slice is to be replaced with the alternative network slice for (a) an amount of UEs or (b) new UEs registering to the network slice, or both (a) and (b).

In one embodiment, the congestion information comprises information that indicates that the network slice is to be replaced with the alternative network slice due to congestion for an amount of UEs. In one embodiment, the amount of UEs is a percentage of UEs. In one embodiment, the amount of UEs is an amount of new UEs requesting to be registered with the network slice. In one embodiment, the amount of UEs is an amount of existing UEs registered with the network slice. In one embodiment, the amount of UEs comprises an amount of existing and new UEs registered or requesting to be registered with the network slice. In one embodiment, the amount of UEs is a function of a congestion level of the network slice.

In one embodiment, the congestion information comprises information that indicates that the network slice is to be replaced with the alternative network slice for new UEs registering to the network slice.

In one embodiment, the congestion information further comprises any one or more of the following: information that indicates that replacement is desired or requested for a specific UE or a specific set of UEs only, information that indicates whether replacement is desired or requested for only new UE requests or also for already registered UEs, and information that indicates a congestion level of the network slice.

In one embodiment, the congestion information further comprises information that indicates that replacement is desired or requested for only new UE requests or also for already registered UEs, wherein already registered UEs comprise one or more UEs that are registered with the network slice with one or more established sessions with the network slice and/or one or more UEs that are registered with the network slice but without any established session or without any activated user plane for a session(s) for the network slice. In one embodiment, the sessions are PDU sessions.

In one embodiment, receiving the congestion information for the network slice comprises receiving a Network Slice Availability Notification comprising the congestion information from the other network node.

In one embodiment, the other network node is a network node implementing an NSSF. In another embodiment, the other network node is a network node implementing an OAM node. In another embodiment, the other network node is a network node implementing a PCF or NWDAF.

In one embodiment, the method further comprises receiving, from the other network node, a trigger to stop replacement of the network slice with the alternative network slice and stopping replacement of the network slice with the alternative network slice responsive to receiving the trigger to stop the replacement.

In one embodiment, the method further comprises receiving, from the other network node, a notification to stop replacement of the network slice with the alternative network slice and stopping replacement of the network slice with the alternative network slice responsive to receiving the notification to stop the replacement.

In one embodiment, the method further comprises receiving, from the other network node, a notification that indicates that the network slice is no longer congested and re-establishing one or more Protocol Data Unit, PDU, sessions of one or more UEs previously established on the alternative network slice on the network slice.

Corresponding embodiments of a network node for implementing an AMF are also disclosed. In one embodiment, a network node for implementing an AMF for a core network of a cellular communications system is adapted to determine that a network slice is to be replaced with an alternative network slice due to congestion in the network slice for (a) an amount of UEs or (b) new UEs registering to the network slice, or both (a) and (b), and replace the network slice with the alternative network slice for (a) the amount of UEs or (b) new UEs registering to the network slice, or both (a) and (b).

In one embodiment, a network node for implementing an AMF for a core network of a cellular communications system comprises processing circuitry configured to cause the network node to determine that a network slice is to be replaced with an alternative network slice due to congestion in the network slice for (a) an amount of UEs or (b) new UEs registering to the network slice, or both (a) and (b), and replace the network slice with the alternative network slice for (a) the amount of UEs or (b) new UEs registering to the network slice, or both (a) and (b).

Systems and methods are disclosed for restricted session transfer between network slices. In one embodiment, a method performed by an Access and Mobility Management Function (AMF) in a core network of a cellular communications system comprises determining an amount of User Equipments (UE) for which a network slice is to be replaced with an alternative network slice due to congestion in the network slice and/or an amount of sessions (e.g., Protocol Data Unit (PDU) session) for which the network slice is to be replaced with the alternative network slice due to congestion in the network slice. The method further comprises performing or initiating one or more actions to replace the network slice with the alternative network slice for the determined amount of UEs and/or the determined amount of sessions. In this manner, load balancing between the network slice and the alternative network slice can be provided when the network slice is congested.

In one embodiment, the method further comprises receiving congestion information for the network slice, wherein determining the amount of UEs and/or the amount of sessions comprises determining the amount of UEs for which the network slice is to be replaced with the alternative network slice and/or the amount of sessions for which the network slice is to be replaced with the alternative network slice, based on the congestion information. In one embodiment, the congestion information comprises any one or more of the following:
information that indicates whether the network slice is unavailable or congested,
information that indicates that replacement is desired or requested for a specific UE or a specific set of UEs only,
information that indicates an amount of UEs and/or sessions for which the network slice is to be replaced with the alternative network slice,
information that indicates whether replacement is desired or requested for only new UE requests or also for already registered UEs and/or established sessions,
congestion level of the network slice.

In one embodiment, the congestion information comprises the information that indicates whether replacement is desired or requested for only new UE requests or also for already registered UEs and/or established PDU sessions, wherein already registered UEs comprise one or more UEs that are registered with the network slice within one or more established sessions (e.g., PDU sessions) with the network slice and/or one or more UEs that are registered with the network slice but without any established session or without any activated user plane for a session(s) for the network slice.

In one embodiment, the sessions are PDU sessions.

In one embodiment, the determined amount of UEs and/or the determined amount of sessions are a determined amount of new UEs requesting to be registered with the network slice and/or a determined amount of new sessions requested to be established with the network slice.

In one embodiment, the determined amount of UEs and/or the determined amount of sessions are a determined amount of existing UEs registered with the network slice and/or a determined amount of existing sessions established on the network slice.

In one embodiment, the determined amount of UEs and/or the determined amount of sessions comprise a determined amount of existing and new UEs registered or requesting to be registered with the network slice and/or a determined amount of existing and new sessions established or requested to be established on the network slice.

In one embodiment, the wherein the determined amount of UEs and/or the determined amount of sessions is/are a function of a congestion level of the network slice.

In one embodiment, performing or initiating one or more actions to replace the network slice with the alternative network slice for the determined amount of UEs and/or the determined amount of sessions comprises sending, to a Session Management Function (SMF), a request to re-establish one or more sessions of one or more UEs with the alternative network slice.

In one embodiment, the method further comprises determining that replacement of the network slice with the alternative network slice is to be stopped and performing or initiating one or more actions to stop replacement of the network slice with the alternative network slice for one or more UEs and/or one or more sessions (e.g., PDU sessions), responsive to determining that replacement of the network slice with the alternative network slice is to be stopped. In one embodiment, the method further comprises receiving information from another network node that indicates that replacement of the network slice with the alternative network slice is to be stopped. In one embodiment, the information that indicates that replacement of the network slice with the alternative network slice is to be stopped comprises updated congestion information for the network slice.

Corresponding embodiments of a network node that implements an AMF are also disclosed.

Embodiments of a method performed by a network node are also disclosed. In one embodiment, a method performed by a network node comprises sending, to a second network node, congestion information for a network slice, wherein the congestion information is provided with or serves as a trigger for replacement of the network slice with an alternative network slice for an amount of UEs and/or an amount of sessions due to congestion at the network slice.

In one embodiment, the congestion information comprises any one or more of the following:
information that indicates whether the network slice is unavailable or congested,
information that indicates that replacement is desired or requested for a specific UE or a specific set of UEs only,
information that indicates an amount of UEs and/or sessions for which the network slice is to be replaced with the alternative network slice,
information that indicates whether replacement is desired or requested for only new UE requests or also for already registered UEs and/or established PDU sessions,
congestion level of the network slice.
   In one embodiment, the congestion information comprises the information that indicates whether replacement is desired or requested for only new UE requests or also for already registered UEs and/or established PDU sessions, wherein already registered UEs comprise one or more UEs that are registered with the network slice within one or more established sessions (e.g., PDU sessions) with the network slice and/or one or more UEs that are registered with the network slice but without any established session or without any activated user plane for a session(s) for the network slice.

In one embodiment, the sessions are Protocol Data Unit, PDU, sessions.

In one embodiment, the amount of UEs and/or the amount of sessions are an amount of new UEs requesting to be registered with the network slice and/or an amount of new sessions requested to be established with the network slice.

In one embodiment, the amount of UEs and/or the amount of sessions are an amount of existing UEs registered with the network slice and/or an amount of existing sessions established on the network slice.

In one embodiment, the amount of UEs and/or the amount of sessions comprise an amount of existing and new UEs registered or requesting to be registered with the network slice and/or an amount of existing and new sessions established or requested to be established on the network slice.

In one embodiment, the determined amount of UEs and/or the determined amount of sessions is/are a function of a congestion level of the network slice.

In one embodiment, the network node is a network node implementing an OAM node, a NSSF, a PCF, or a NWDAF.

Corresponding embodiments of a network node are also disclosed.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications system in which embodiments of the present disclosure may be implemented;

FIG. 2 illustrates a wireless communication system represented as a Fifth Generation (5G) network architecture composed of core Network Functions (NFs);

FIG. 3 illustrates an example of a roaming 5G network architecture using;

FIGS. 4A and 4B illustrate the operation of an example embodiment of a cellular communications system in accordance with embodiments of the present disclosure;

FIG. 5 is a schematic block diagram of a network node according to some embodiments of the present disclosure;

FIG. 6 is a schematic block diagram that illustrates a virtualized embodiment of the network node according to some embodiments of the present disclosure; and

FIG. 7 is a schematic block diagram of the network node according to some other embodiments of the present disclosure.

### DETAILED DESCRIPTION

Some of the embodiments contemplated herein will now be described more fully with reference to the accompanying drawings. Other embodiments, however, are contained within the scope of the subject matter disclosed herein, the disclosed subject matter should not be construed as limited to only the embodiments set forth herein; rather, these embodiments are provided by way of example to convey the scope of the subject matter to those skilled in the art.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station (e.g., a network node that implements a gNB Central Unit (gNB-CU) or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing an Access and Mobility Management Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

Also note that the terms “network slice” and “S-NSSAI” are used interchangeably in the description provided herein unless otherwise indicated.

There currently exist certain challenge(s) for transferring UEs and/or Protocol Data Unit (PDU) sessions from one network slice to another. The current solution assumes that a Single Network Slice Selection Assistance Information (S-NSSAI) (i.e., a network slice) being not available implies that all PDU sessions established on that S-NSSAI for a UE or all UEs need for the S-NSSAI to be replaced with an Alternative S-NSSAI. While this complete transfer is valid for an S-NSSAI that is temporarily not available or out of service, it is not necessarily applicable to an S-NSSAI experiencing congestion. A complete transfer of all PDU sessions in the latter case can or likely will lead to a congestion in the Alternative S-NSSAI. Hence, for the latter case, a partial transfer of PDU sessions is sufficient to eliminate congestion in the S-NSSAI experiencing congestion. Indeed, S-NSSAIs experiencing congestion could in certain cases represent the majority of the S-NSSAIs.

Certain aspects of the present disclosure and their embodiments may provide solutions to the aforementioned or other challenges. Systems and methods are disclosed herein that extend the current functionality by enabling the AMF, in case of a congested S-NSSAI, to transfer only a limited number of PDU sessions from the congested S-NSSAI to the Alternative S-NSSAI, or to temporarily use the Alternative S-NSSAI for new UE requests. In one embodiment, the AMF decides on the amount (e.g. percentage) of PDU sessions to be transferred and which UEs are to be impacted based on an internal process or based on information received from another network node(s) such as, e.g., the Network Slice Selection Function (NSSF), Operations, Administration, and Maintenance (OAM), and/or the Policy Control Function (PCF) e.g. until the AMF receives an indication to stop the replacement (i.e., an indication to stop using the Alternative S-NSSAI and resume using the original S-NSSAI, e.g., for the impacted PDU sessions).

This extension implies that the congested network slice is still in service in case of congestion and cannot be assumed out of service. It can also be used if the AMF deems that level of congestion is acceptable without needing to use the Alternative S-NSSAI as is the case with the current functionality that does not distinguish congestion of a slice from a slice temporarily out of service.

Certain embodiments may provide one or more of the following technical advantage(s). Embodiments of the present disclosure may enable dynamic load balancing between a network slice and an associated alternative network slice in case of congestion in the network slice. Embodiments may additionally or alternatively minimize the service interruption by replacing only new registrations and avoid replacing UEs that are already using a network slice for some service. Embodiments also enable replacement to be stopped when there is no longer a need of doing replacement such that it is only needed to change back network slices for smaller set of UE.

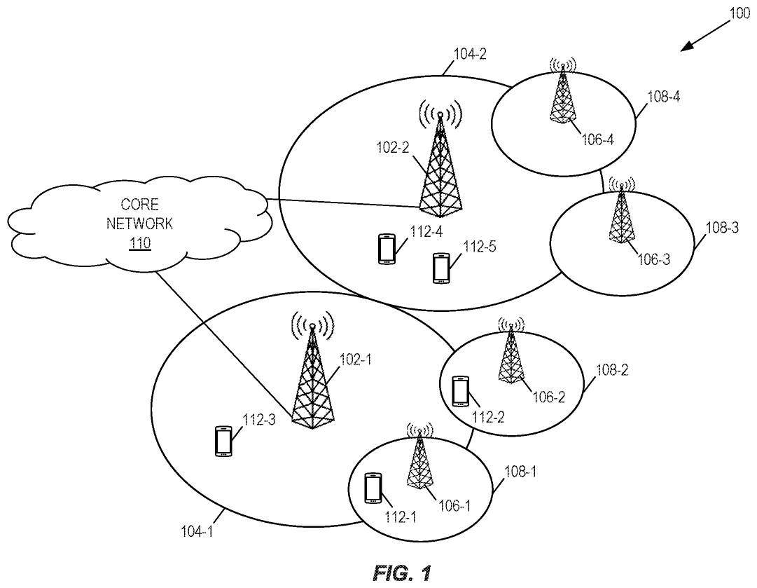

FIG. 1 illustrates one example of a cellular communications system 100 in which embodiments of the present disclosure may be implemented. In the embodiments described herein, the cellular communications system 100 is a 5G system (5GS) including a Next Generation RAN (NG-RAN) and a 5G Core (5GC); however, the present disclosure is not limited to the 5GS and may be used in other (e.g., future) cellular communications system such as, e.g., the EPS or 6^{th} Generation (6G) system. In this example, the RAN includes base stations 102-1 and 102-2, which in the 5GS include NR base stations (gNBs) and optionally next generation eNBs (ng-eNBs) (e.g., LTE RAN nodes connected to the 5GC), controlling corresponding (macro) cells 104-1 and 104-2. The base stations 102-1 and 102-2 are generally referred to herein collectively as base stations 102 and individually as base station 102. Likewise, the (macro) cells 104-1 and 104-2 are generally referred to herein collectively as (macro) cells 104 and individually as (macro) cell 104. The RAN may also include a number of low power nodes 106-1 through 106-4 controlling corresponding small cells 108-1 through 108-4. The low power nodes 106-1 through 106-4 can be small base stations (such as pico or femto base stations) or RRHs, or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The cellular communications system 100 also includes a core network 110, which in the 5GS is referred to as the 5GC. The base stations 102 (and optionally the low power nodes 106) are connected to the core network 110.

The base stations 102 and the low power nodes 106 provide service to wireless communication devices 112-1 through 112-5 in the corresponding cells 104 and 108. The wireless communication devices 112-1 through 112-5 are generally referred to herein collectively as wireless communication devices 112 and individually as wireless communication device 112. In the following description, the wireless communication devices 112 are oftentimes UEs, but the present disclosure is not limited thereto.

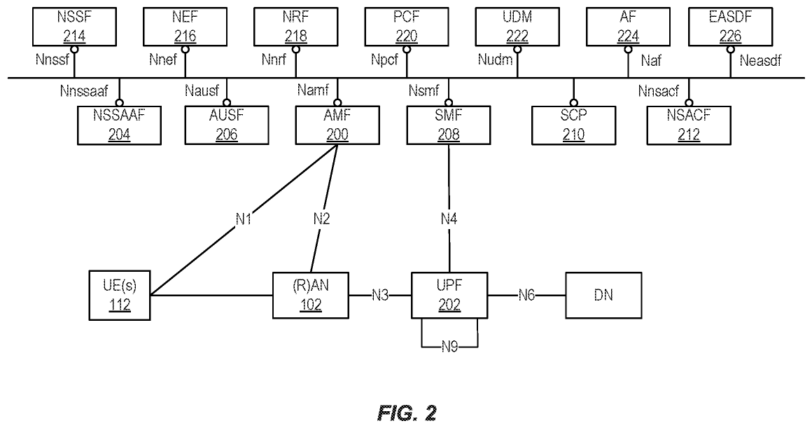

FIG. 2 illustrates a 5G network architecture, which can be understood as one example embodiment of the cellular communications system 100 of FIG. 1. As illustrated, from the access side, the 5G network architecture shown in FIG. 2 includes UEs 112 connected to a RAN 102 or Access Network (AN) as well as an AMF 200. Typically, theR(AN) 102 comprises base stations, e.g. such as eNBs or gNBs or similar. Seen from the core network side, the 5GC NFs shown in FIG. 2 include the AMF 200, UPF 202, NSSAAF 204, AUSF 206, SMF 208, SCP 210, NSACF 212, NSSF 214, NEF 216, NRF 218, PCF 220, UDM 222, AF 224, and EASDF 226.

An NF may be implemented either as a network element on a dedicated hardware, as a software instance running on a dedicated hardware, or as a virtualized function instantiated on an appropriate platform, e.g., a cloud infrastructure.

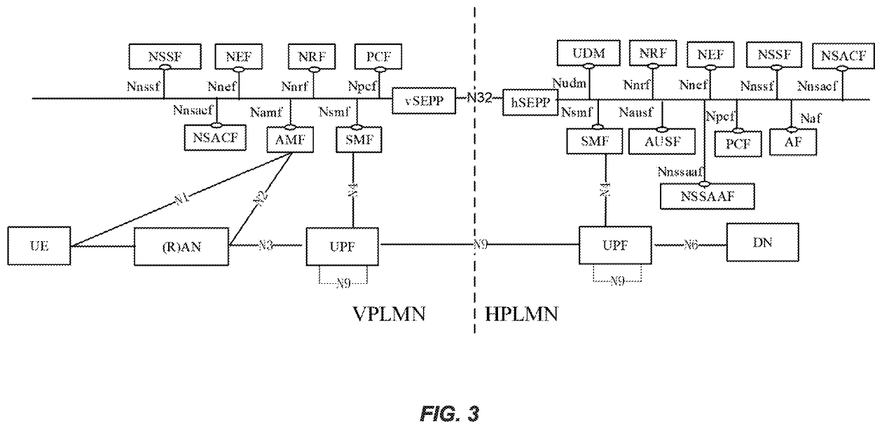

FIG. 3 illustrates an example 5G roaming architecture for the home routed scenario, which can be understood as another example embodiment of the cellular communications system 100 of FIG. 1. While not numbered, the elements in the Home Public Land Mobile Network (HPLMN) are sometimes referenced herein by the reference number of the corresponding element in FIG. 2 but with “-H” appended to the reference number. Likewise, the elements in the Visited Public Land Mobile Network (VPLMN) are sometimes referenced herein by the reference number of the corresponding element in FIG. 2 but with “-V” appended to the reference number. For example, the UPF in the VPLMN may be referenced herein as UPF 202-V (or visited UPF 202-V), whereas the UPF in the HPLMN may be referenced herein as UPF 202-H (or home UPF 202-H).

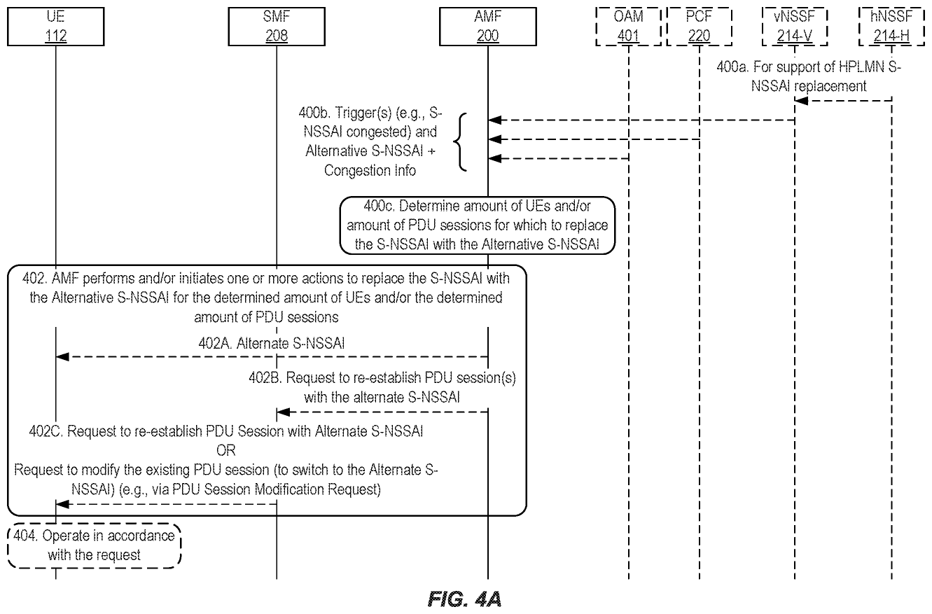

FIGS. 4A and 4B illustrate a procedure in which the AMF 200 operates in accordance with one embodiment of the present disclosure. Optional elements and steps are represented by dashed lines/boxes.

The AMF 200 receives an Alternative S-NSSAI for an S-NSSAI and congestion information for the S-NSSAI (steps 400a and 400b). The AMF 200 may receive the Alternative S-NSSAI and congestion information via any suitable mechanism. For example, in one embodiment, the AMF 200 receives the congestion information from an OAM node 401, the PCF 220, or an NSSF 214 (e.g., the vNSSF 214-V in the illustrated example). This congestion information may be provided upon request from the AMF 200, provided and updated dynamically (e.g., periodically) by the OAM 401, the PCF 220, or the NSSF 214, or provided by the OAM 401, the PCF 220, or the NSSF 214 when one or more predefined triggering criteria are satisfied (e.g., congestion level of the S-NSSAI reaches a predefined or configured threshold congestion level). In one example embodiment described below for the example implementation in the context of 3GPP TS 23.501, in step 400b, the AMF 200 receives, from the NSSF 214 or OAM 401, a notification (specifically a “Network Slice Availability Notification”) that the S-NSSAI is unavailable where this notification includes the Alternative S-NSSAI and, if the cause is “congestion”, the congestion information. Thus, in one embodiment, the congestion information received by the AMF 200 in step 400b may be included in a Network Slice Availability Notification for the network slice.

In one embodiment, the congestion information received by the AMF 200 in step 400b may include information enabling the AMF 200 to determine the amount of replacements to be done. For example, in one embodiment, the congestion information includes any one or more of the following:
information that indicates whether the S-NSSAI is unavailable (i.e., all usage of S-NSSAI is to be replaced) or congested (i.e., the S-NSSAI is still in service and only some amount of replacement is to be done),
information that indicates that replacement is desired or requested for a specific UE or a specific set of UEs only (i.e., AMF is to replace the S-NSSAI only for a specific UE(s)),
information that indicates an amount of replacements to be done, e.g. number of or percentage of new UE requests or number of or percentage of existing UEs and/or PDU sessions to be transferred or switched to the Alternative S-NSSAI,
information that indicates whether replacement is desired or requested for only new UE requests or also for already registered UEs and/or established PDU sessions,
congestion level of the S-NSSAI.
   To be clear, the congestion information may include any one of the different information listed above or any combination of two or more of the different information listed above. Also note that the “already registered UEs” may include UEs that are registered with the S-NSSAI with one or more established PDU sessions for the S-NSSAI and/or UEs that are registered with the S-NSSAI that do not have any established PDU session(s) for the S-NSSAI or any established user plane for a PDU sessions(s) for the S-NSSAI.

Based on the congestion information for the S-NSSAI, the AMF 200 determines an amount of UEs and/or an amount of PDU sessions for which the S-NSSAI is to be replaced with the Alternative S-NSSAI and, optionally, whether the determined amount of UEs and/or PDU sessions are only new UEs and/or new PDU sessions or also existing UEs and/or existing PDU sessions (step 400c). In one embodiment, the determination in step 400c also includes determining the specific UE(s) and/or PDU session(s) to be transferred to the Alternative S-NSSAI. Alternatively, one or more of the specific UE(s) to be transferred (for UE(s) for which associated PDU session(s) are to be transferred) are indicated in step 400b.

For example, in one embodiment, the congestion information indicates that the S-NSSAI is unavailable, in which case the AMF 200 decides that the S-NSSAI is to be replaced by the Alternative S-NSSAI for all UEs/PDU sessions (e.g., all UEs/PDU sessions existing on the S-NSSAI and, optionally, all new UEs/PDU sessions requested to be registered/established on the S-NSSAI).

As another example, in one embodiment, the congestion information indicates that the S-NSSAI is congested (and thus still in service) but that some replacement needs to be done. In this example, the congestion information may include the congestion level or information that indicates a specific UE or a specific set of UEs for which the associated PDU sessions are to be transferred to the Alternative S-NSSAI. In this case, the AMF 200 determines that S-NSSAI is to be replaced with the Alternative S-NSSAI for the PDU session(s) of the indicated UE or indicated set of UEs. In addition or alternatively, the congestion information may include information that indicates an amount of UEs and/or PDU sessions for which the S-NSSAI is to be replaced with the Alternative S-NSSAI. In this case, in one embodiment, the AMF 200 selects the specific UEs and/or PDU sessions to for which the S-NSSAI is to be replaced with the Alternative S-NSSAI, where amount of UEs and/or PDU sessions selected corresponds to the determined amount of UEs and/or PDU sessions for which replacement is to be performed. Further, in one embodiment, whether the congestion information indicates the specific UE or set of UEs for which replacement is to be performed or indicates the amount of UEs and/or PDU sessions for which replacement is to be performed, the congestion information also indicates whether this applies to only new UEs and/or new PDU sessions or if it also applies to existing UEs and/or existing PDU sessions.

As another example, in one embodiment, the congestion information indicates that replacement is only to be applied to new UEs and/or new PDU sessions. In this case, the AMF 200 decides, e.g., new registration requests and/or new PDU sessions for, e.g., specifically indicated UE(s) and/or for an indicated amount of UEs and/or PDU sessions use the Alternative S-NSSAI rather than the (congested)S-NSSAI.

As a final example, in one embodiment, the congestion information includes information that indicates the congestion level of the S-NSSAI. In this case, the AMF 200 decides an amount of UEs and/or an amount of PDU sessions for which the S-NSSAI is to be replaced with the Alternative S-NSSAI and, optionally, whether the determined amount of UEs and/or PDU sessions are only new UEs and/or new PDU sessions or also existing UEs and/or existing PDU sessions, based on the congestion level of the S-NSSAI.

Note that, in one embodiment, at any time the OAM 401, NSSF 214, or PCF 220 may update the congestion information. Such an update may include, in one embodiment, an indication to stop performing replacement of S-NSSAI to Alternative S-NSSAI.

The AMF 200 then performs or initiates one or more actions to replace the S-NSSAI with the Alternative S-NSSAI for the determined amount of UEs and/or the determined amount of PDU sessions (step 402). Note that these actions may vary depending on whether replacement is to be performed only for new UEs/PDU Sessions or whether replacement is also to be performed for existing UEs/PDU Sessions. In one example, the AMF 200 sends the Alternate S-NSSAI to the UE 112 (step 402A). The AMF 200 sends, to the SMF 208, a request(s) to re-establish the PDU session(s) of the determined amount of UEs and/or the determined amount of PDU sessions with the Alternative S-NSSAI (step 402B). Note that, in one embodiment, the request(s) indicates the specific UEs and/or PDU sessions for which replacement is to be stopped. For each impacted UE (i.e., each for which the S-NSSAI is being replaced with the Alternative S-NSSAI and/or for each UE associated to a PDU session for which the S-NSSAI is being replaced with the Alternative S-NSSAI), the SMF 208 then sends a request to the UE 112 to either re-establish a PDU session (previously established on the S-NSSAI) on the Alternative S-NSSAI or to modify an existing PDU session (using the S-NSSAI) to use the Alternative S-NSSAI (step 402C).

The UE 112 operates in accordance with the request such that the PDU session(s) is (are) transferred/established with the Alternative S-NSSAI (step 404). In another embodiment, the AMF 200 interacts (e.g., directly) with the Network

Data Analytics Function (NWDAF) to retrieve the congestion level of the S-NSSAI and the uses this information (e.g., in step 402) determine the amount of replacement to be done with or without additional information from OAM 401, NSSF 214, or PCF 220. The process may then proceed as described above.

Optionally, a similar process may be used to stop replacement of the S-NSSAI with the Alternative S-NSSAI, e.g., once the S-NSSAI is no longer congested or once the congestion level of the S-NSSAI has dropped to a predefined or configured acceptable congestion level. In this regard, the AMF 200 receives a trigger(s) to stop replacement (steps 406a and 406b). The trigger(s) may be provided with updated congestion information (e.g., congestion information including information that indicates that replacement is to be stopped, e.g., for all UEs and/or PDU sessions, for some UEs and/or PDU sessions (e.g., all existing UEs and/or PDU sessions using the Alternative S-NSSAI and/or new UEs and/or PDU sessions for the S-NSSAI). Note that, in one embodiment, the updated congestion information is the trigger(s) to stop replacement. The AMF 200 may receive this trigger(s) via any suitable mechanism. For example, in one embodiment, the AMF 200 receives the trigger(s) to stop replacement from OAM 401, the PCF 220, or the NSSF 214 (e.g., the vNSSF 214-V in the illustrated example).

In response to the trigger(s) to stop replacement, the AMF 200 determines that replacement of the S-NSSIA with the Alternative S-NSSAI is to be stopped (step 406c). In one embodiment, step 406c includes determining the UEs for which replacement is to be stopped and/or the UEs associated to the PDU sessions for which replacement is to be stopped. Note that, in one embodiment, if replacement is to be stopped for only some UEs and/or only some PDU sessions, the AMF 200 determines the amount of UEs and/or PDU sessions for which replacement is to be stopped and/or the UE(s) and/or PDU session(s) for which replacement is to be stopped.

The AMF 200 then performs or initiates one or more actions to stop replacement of the S-NSSAI with the Alternative S-NSSAI, e.g., for the determined UEs and/or the UEs associated to the determined PDU sessions (step 408). In one example, the AMF 200 sends, to the SMF 208, a request(S) to re-establish the PDU session(s) of the determined amount of UEs and/or the determined amount of PDU sessions with the S-NSSAI (step 408A). Note that, in one embodiment, the request(s) indicates the specific UEs and/or PDU sessions for which replacement is to be stopped. For each impacted UE (i.e., for each UE for which replacement of the S-NSSAI with the Alternative S-NSSAI is to be stopped and/or each UE associated to a PDU session(s) for which replacement of the S-NSSAI with the Alternative S-NSSAI is to be stopped), the SMF 208 then sends a request to the UE 112 to either re-establish a PDU session (previously established on the Alternative S-NSSAI) on the S-NSSAI or to modify an existing PDU session (using the Alternative S-NSSAI) to use the S-NSSAI (step 406C).

The UE 112 operates in accordance with the request such that the PDU session(s) is (are) transferred/established with the S-NSSAI (step 410).

In another embodiment, the AMF 200 interacts (e.g., directly) with the Network Data Analytics Function (NWDAF) to retrieve the congestion level of the S-NSSAI and the uses this information (e.g., in step 406c) that replacement is to be stopped. The process may then proceed as described above.

One example implementation of at least some aspects of the embodiments described herein can be implemented as changes to 3GPP TS 23.501 V18.1.0 as shown below (changes shown in underlined text):

***** START CHANGES TO TS 23.501 *****

| | |
|---|---|
| 5.15.19 | Support of Network Slice Replacement |

The Network Slice Replacement feature is used to replace an S-NSSAI with an Alternative S-NSSAI when an S-NSSAI
becomes unavailable or congested. The Network Slice Replacement may be triggered in the following cases:

| | |
|---|---|
| - | If the NSSF detects that an S-NSSAI becomes unavailable or congested (e.g. based on OAM or NWDAF |
| | analytics output), the NSSF [symbol] sends network slice availability notification for the S-NSSAI to the AMF. The |
| | notification may include an Alternative S-NSSAI which can be used by the AMF to replace the S-NSSAI, and |
| | congestion information if the S-NSSAI is congested. The NSSF notifies the AMF when the S-NSSAI is available |
| | again. |
| - | If the PCF detects that an S-NSSAI becomes unavailable or congested for a UE (e.g. based on OAM or NWDAF |
| | analytics output), the PCF [symbol] sends access and mobility related policy notification to the AMF. The notification |
| | may include an Alternative S-NSSAI which can be used by the AMF to replace the S-NSSAI. The PCF notifies |
| | the AMF when the S-NSSAI is available again for the UE. |
| - | The OAM sends notification to AMF when an S-NSSAI becomes unavailable or congested (and also when this S- |
| | NSSAI becomes available again) and provides the Alternative S-NSSAI to AMF and the OAM may provide |
| | congestion information if the S-NSSAI is congested. |

Based on the notification above from NSSF or PCF or OAM, the AMF may determine that an S-NSSAI is to be replaced
with Alternative S-NSSAI.
If the notification is from NSSF or OAM, the notification includes a cause. If the cause is congestion additional
congestion information can be included and the congestion information is used by the AMF to determine the amount of
UEs to execute the replacement on. If the cause is congestion and the AMF receives no congestion information the AMF
executes the replacement until the OAM or NSSF notifies the AMF to stop the replacement.
For roaming case, the AMF may receive network slice availability notification of the HPLMN S-NSSAI from NSSF in
the HPLMN via NSSF in VPLMN, to trigger the Network Slice Replacement of the HPLMN S-NSSAI as described in
clause 5.15.6.

| NOTE 1: | It is recommended that, the operator configures to use only one mechanism when triggering |
|---|---|
| | the Network Slice Replacement for S-NSSAI. |

The AMF determines the Alternative S-NSSAI for a UE registered with the S-NSSAI based on the notification from
NSSF or PCF, or based on local configuration if the NSSF or PCF do not provide an alternative S-NSSAI. The
Alternative S-NSSAI shall be supported in the UE Registration Area. If AMF cannot determine the Alternative S-NSSAI
for the S-NSSAI, e.g. PCF or NSSF doesn't provide Alternative S-NSSAI, the AMF may further interact with the PCF to
determine the Alternative S-NSSAI. The event trigger in AMF for interacting with PCF is described in clause 6.1.2.5 of
TS 23.503 [45].
The UE indicates the support of Network Slice Replacement feature during the UE Registration procedure. For
supporting UE in CM-CONNECTED mode, and if there is a PDU Sessions in the UE context associated with the S-
NSSAI that needs to be replaced, the AMF provides the Alternative S-NSSAI for this S-NSSAI in the Allowed NSSAI
and in the Configured NSSAI, if not included yet, and the mapping between S-NSSAI(s) to Alternative S-NSSAI(s) to
the UE in UE Configuration Update message as follows:

| | |
|---|---|
| - | for non-roaming UEs, the AMF provides the mapping of the S-NSSAI to the Alternative S-NSSAI to the UE. |
| - | for roaming UEs when the VPLMN S-NSSAI has to be replaced by a VPLMN Alternative S-NSSAI, the AMF |
| | provides the mapping of the VPLMN S-NSSAI to the Alternative VPLMN S-NSSAI to the UE. |
| - | for roaming UEs when the HPLMN S-NSSAI has to be replaced by an Alternative HPLMN S-NSSAI, the AMF |
| | provides the mapping of the HPLMN S-NSSAI to the Alternative HPLMN S-NSSAI to the UE. |

| NOTE 2: | The Alternative S-NSSAI or Alternative HPLMN S-NSSAI may be part or not part of the |
|---|---|
| | Subscribed S-NSSAI. |

For the supporting UE in CM-IDLE state, when the UE establishes a NAS signalling connection, e.g. through a Service
Request procedure or through a UE registration procedure, if the AMF determines that the S-NSSAI is to be replaced and
there is a PDU Session associated with the S-NSSAI in the UE context, the AMF sends the mapping of the S-NSSAI to
the Alternative S-NSSAI to the UE in the UE Configuration Update message or in the Registration Accept message.
Editor's note: Whether to send the mapping of the S-NSSAI to the Alternative S-NSSAI to the UE when there is no

PDU session associated with the S-NSSAI is FFS.

During a new PDU Session establishment procedure towards an S-NSSAI,

| | |
|---|---|
| - | if the UE is provided with the mapping of the S-NSSAI to an Alternative S-NSSAI, the UE provides both the |
| | Alternative S-NSSAI and the S-NSSAI in the PDU Session Establishment message. When the AMF receives the |
| | Alternative S-NSSAI and the S-NSSAI in the PDU Session Establishment message, or when the AMF receives |
| | only the S-NSSAI in PDU Session Establishment message the AMF determines that the S-NSSAI is to be |
| | replaced with the Alternative S-NSSAI, the AMF includes both the Alternative S-NSSAI and the S-NSSAI to the |
| | SMF. |
| - | if the UE is not provided with the mapping of the S-NSSAI to the Alternative S-NSSAI, the UE provides the S- |
| | NSSAI in the PDU Session Establishment message. When the AMF determines that the requested S-NSSAI is to |
| | be replaced with the Alternative S-NSSAI and if the UE supports Network Slice Replacement, the AMF performs |
| | UE Configuration Update procedure to reconfigure the UE with the Alternative S-NSSAI. The AMF continues |
| | the PDU Session establishment procedure with the Alternative S-NSSAI and provides both the Alternative S- |
| | NSSAI and the S-NSSAI to the SMF. |

The SMF proceeds with the PDU Session establishment using the Alternative S-NSSAI. The SMF sends the Alternative
S-NSSAI to NG-RAN in N2 SM information and to UE in PDU Session Establishment Accept message.
For existing PDU Session associated with an S-NSSAI that is replaced with the Alternative S-NSSAI, after the AMF
sends mapping of the S-NSSAI to the Alternative S-NSSAI to the supporting UE in UE Configuration Update message,
the AMF sends updates to the SMF of the PDU Session, e.g. triggering Nsmf_PDUSession_UpdateSMContext service
operation, that the PDU Session is to be transferred to Alternative S-NSSAI and includes the Alternative S-NSSAI as
follows (see details in clause 4.3.5.x of TS 23.502 [3]):

| | |
|---|---|
| - | If the SMF determines that the PDU Session needs to be retained (e.g. if the anchor UPF can be reused with the |
| | alternative S-NSSAI and SSC mode 1), the SMF sends the Alternative S-NSSAI to the UPF in the N4 message, to |
| | the NG-RAN in N2 message and to the supporting UE in PDU Session Modification Command message. |
| - | If the SMF determines that the PDU Session needs to be re-established, the SMF sends the Alternative S-NSSAI |
| | to the supporting UE either in PDU Session Modification Command if the PDU Session is of SSC mode 3, or in |
| | PDU Session Release if the PDU Session is of SSC mode 2 or SSC mode 1, to trigger the re-establishment of the |
| | PDU Session. The UE includes both, the S-NSSAI and the Alternative S-NSSAI in the PDU Session |
| | Establishment message. |

```
  Editor's note: How to use the existing NG-RAN resource of the replaced S-NSSAI is for FFS.
When the AMF is notified that the S-NSSAI is available again or the congestion of the S-NSSAI has been mitigated, if
the AMF has configured the supporting UE with the Alternative S-NSSAI, and the AMF determines for the UE to use
the S-NSSAI again, the AMF reconfigures the supporting UE (e.g. by using UE Configuration Update message) to use
the S-NSSAI. If there is an existing PDU Session associated with the Alternative S-NSSAI, the AMF sends updates to
the SMF of the PDU Session, e.g. triggering Nsmf_PDUSession_UpdateSMContext service operation, that the PDU
Session is to be transferred to the S-NSSAI.
  Editor's note: How to perform Network Slice Replacement during handover is FFS.
```

***** END CHANGES TO TS 23.501 *****

One example implementation of at least some aspects of the embodiments described herein can be implemented as changes to 3GPP TS 23.502 V18.1.0 as shown below (changes shown in underlined text):

| | ***** START CHANGES TO TS 23.501 ***** |
|---|---|
| 5.2.16.3 | Nnssf_NSSAIAvailability service |
| 5.2.16.3.1 | General |

Service description: This service enables to update the AMFs and the NSSF on the
availability of S-NSSAIs and NSAGs on a per TA basis. This service also provides an
Alternative S-NSSAI to the NF Service Consumer in case when the NSSF determines that
an S-NSSAI has to be replaced with an Alternative S-NSSAI.

| NOTE: | The NSSF can determine the serving network and Access Type from the TAI, as |
|---|---|
| | described in TS 29.571 [70]. |

When this service is used by the NSSF to provide to the AMF an Alternative S-NSSAI to
the S-NSSAI to be replaced, the following cases are possible:

| | |
|---|---|
| - | in non-roaming and in roaming case, NSSF in the Serving PLMN provides to the AMF the Alternative S-NSSAI |
| | of the Serving PLMN; or |
| - | in roaming case, the NSSF in the HPLMN provides to the NSSF in the VPLMN the Alternative HPLMN S- |
| | NSSAI; and the NSSF in the VPLMN provides to the AMF the Alternative HPLMN S-NSSAI. |

| | ***** NEXT CHANGE TO TS 23.501 ***** |
|---|---|
| 5.2.16.3.4 | Nnssf_NSSAIAvailability_Subscribe service operation |

```
Service operation name: Nnssf_NSSAIAvailability_Subscribe
Description: This service operation enables a NF Service Consumer (e.g. AMF) to subscribe to a notification of any
changes in status of the NSSAI availability information (e.g. S-NSSAIs and optionally NSI IDs available per TA and the
restricted S-NSSAI(s) and optionally NSI IDs per PLMN in that TA in the serving PLMN of the UE) upon this is
updated by another AMF. This service also enables the NF Service Consumer (e.g. AMF or NSSF in the VPLMN) to
subscribe to a notification when an S-NSSAI has to be replaced by an Alternative S-NSSAI.
Inputs, Required: Callback URI of the NF Service Consumer [symbol]   .
Inputs, Conditional Required:
If this service operation is invoked to subscribe for changes in status of the NSSAI availability information, then the
following inputs are required:
  - list of TAIs supported by the NF [symbol]   Service [symbol]   Consumer, event to be subscribed.
If this service operation is invoked to subscribe to a notification when any S-NSSAI has to be replaced by an Alternative
S-NSSAI, then the following inputs are required:
  - for the S-NSSAI of the serving PLMN: set of S-NSSAIs served by the NF Service Consumer that may be
```

replaced, NF type of the NF Service Consumer (e.g. AMF), Requester ID.

- for HPLMN S-NSSAI: S-NSSAIs for the HPLMN, NF type of the NF Service Consumer (e.g. AMF or NSSF),

Requester ID.

Inputs, Optional: Expiry time.
Outputs, Required: SubscriptionID. [symbol]
Outputs, Conditional Required:
If this service operation is invoked to subscribe for changes in status of the NSSAI availability information, then the
following outputs are required:
- Expiry time (if present in the request, may be included in the response based on operator's policy and taking into

account the expiry time present in the request (i.e. should be less than or equal to that value); if not present in the
request, may be included in the response based on operator's policy. Whatever the case, if not included in the
response, this means that the subscription is valid without an expiry time0).

Outputs, Optional:
If this service operation is invoked to subscribe for changes in status of the NSSAI availability information, then the
following outputs are required:

| | |
|---|---|
| - | A list of TAIs and, for each TAI, the S-NSSAIs and optionally NSI IDs supported by the AMF and 5G-AN and |
| | authorized by the NSSF for the TAI and a list of S-NSSAIs and optionally NSI IDs restricted per PLMN for the |
| | TAI. |

If this service operation is invoked to subscribe to a notification when an Alternative S-NSSAI has to replace an S-
NSSAI, then the following outputs are required:
- for the S-NSSAI of the serving PLMN: an Alternative S-NSSAI and the corresponding mapping to the S-NSSAI

to be replaced.

- for HPLMN S-NSSAI: an Alternative S-NSSAI and the corresponding mapping to the S-NSSAIs of the HPLMN,

PLMN ID.

```
  - Cause, i.e. replacement, congestion, stop replacement, or S-NSSAI is available again.
  - Congestion information, if cause is congestion.
```

***** END CHANGES TO TS 23.501 *****

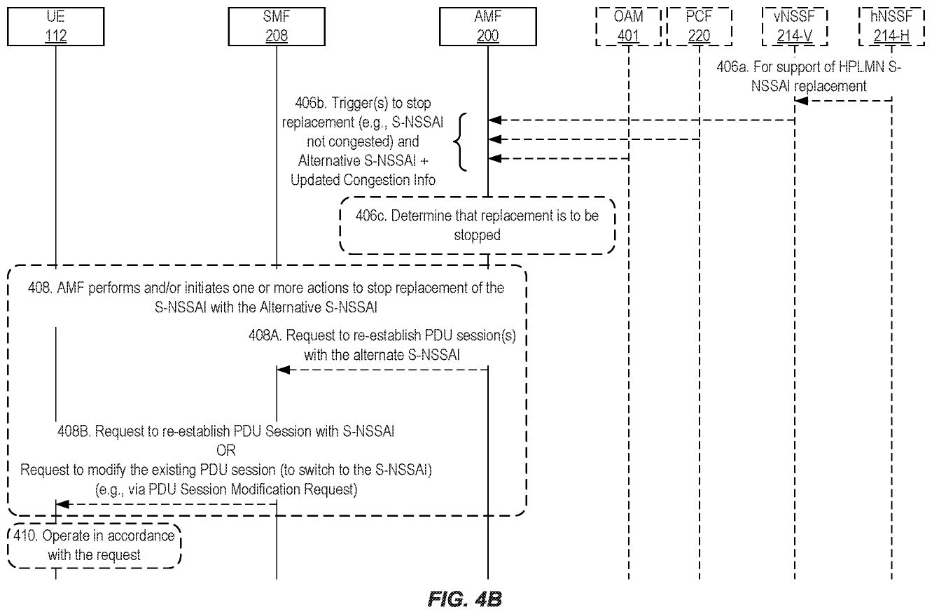

FIG. 5 is a schematic block diagram of a network node 500 according to some embodiments of the present disclosure. Optional features are represented by dashed boxes. The network node 500 may be, for example, a network node that implements all or part of the functionality of a NF such as, e.g., the AMF 200, the SMF 208, the NSSF, 214, the PCF 220, or an OAM node 401, e.g., in accordance with the process of FIGS. 4A and 4B. As illustrated, the network node 500 includes one or more processors 504 (e.g., Central Processing Units (CPUs), Application Specific Integrated Circuits (ASICs), Field Programmable Gate Arrays (FPGAs), and/or the like), memory 506, and a network interface 508. The one or more processors 504 are also referred to herein as processing circuitry. The one or more processors 504 operate to provide one or more functions of the network node 500 as described herein (e.g., one or more functions of the AMF 200, the SMF 208, the NSSF, 214, the PCF 220, or the OAM node 401, e.g., in accordance with the process of FIGS. 4A and 4B). In some embodiments, the function(s) are implemented in software that is stored, e.g., in the memory 506 and executed by the one or more processors 504.

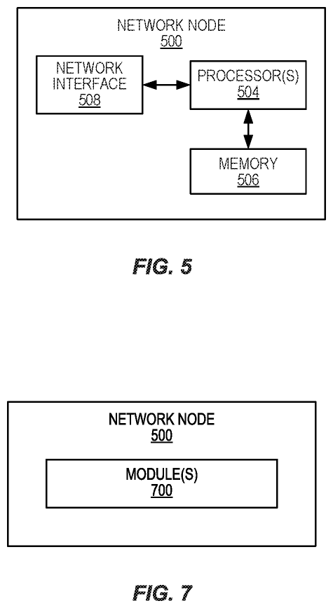

FIG. 6 is a schematic block diagram that illustrates a virtualized embodiment of the network node 500 according to some embodiments of the present disclosure. Again, optional features are represented by dashed boxes. As used herein, a “virtualized” network node is an implementation of the network node 500 in which at least a portion of the functionality of the network node 500 is implemented as a virtual component(s) (e.g., via a virtual machine(s) executing on a physical processing node(s) in a network(s)). As illustrated, the network node 500 includes one or more processing nodes 600 coupled to or included as part of a network(s) 602. Each processing node 600 includes one or more processors 604 (e.g., CPUs, ASICs, FPGAs, and/or the like), memory 606, and a network interface 608.

In this example, functions 610 of the network node 500 described herein (e.g., one or more functions of the AMF 200, the SMF 208, the NSSF, 214, the PCF 220, or the OAM node 401, e.g., in accordance with the process of FIGS. 4A and 4B) are implemented at the one or more processing nodes 600 in any desired manner. In some particular embodiments, some or all of the functions 610 of the network node 500 described herein are implemented as virtual components executed by one or more virtual machines implemented in a virtual environment(s) hosted by the processing node(s) 600.

In some embodiments, a computer program including instructions which, when executed by at least one processor, causes the at least one processor to carry out the functionality of the network node 500 or a node (e.g., a processing node 600) implementing one or more of the functions 610 of the network node 500 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

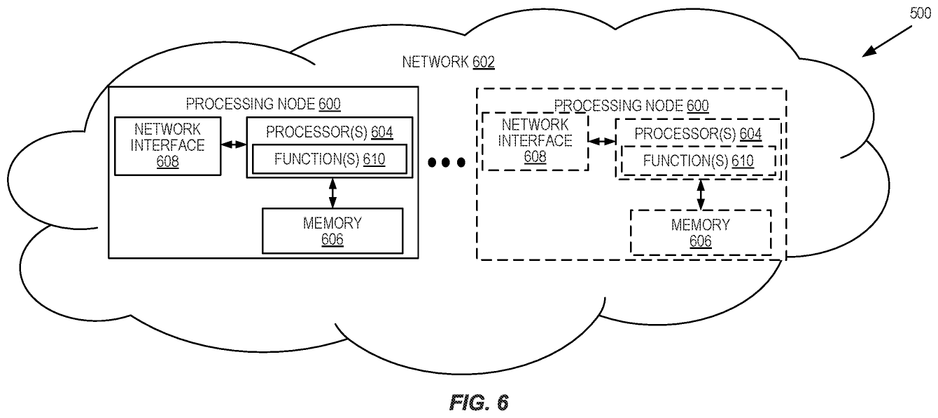

FIG. 7 is a schematic block diagram of the network node 500 according to some other embodiments of the present disclosure. The network node 500 includes one or more modules 700, each of which is implemented in software. The module(s) 700 provide the functionality of the network node 500 described herein. This discussion is equally applicable to the processing node 600 of FIG. 6 where the modules 700 may be implemented at one of the processing nodes 600 or distributed across multiple processing nodes 600 and/or distributed across the processing node(s) 600 and the control system 502.

Any appropriate steps, methods, features, functions, or benefits disclosed herein may be performed through one or more functional units or modules of one or more virtual apparatuses. Each virtual apparatus may comprise a number of these functional units.

These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according to one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

Some example embodiments of the present disclosure are as follows:

Embodiment 1: A method performed by an Access and Mobility Management Function, AMF, (200) in a core network (110) of a cellular communications system (100), the method comprising: determining (400c) an amount of User Equipments, UE, for which a network slice is to be replaced with an alternative network slice due to congestion in the network slice and/or an amount of sessions (e.g., Protocol Data Unit, PDU, session) for which the network slice is to be replaced with the alternative network slice due to congestion in the network slice; and performing or initiating (402) one or more actions to replace the network slice with the alternative network slice for the determined amount of UEs and/or the determined amount of sessions.

Embodiment 2: The method of embodiment 1 further comprising: receiving (400b) congestion information for the network slice, wherein determining (400c) the amount of UEs and/or the amount of sessions comprises determining (400c) the amount of UEs for which the network slice is to be replaced with the alternative network slice and/or the amount of sessions for which the network slice is to be replaced with the alternative network slice, based on the congestion information.

Embodiment 3: The method of embodiment 2 wherein the congestion information comprises any one or more of the following: information that indicates whether the network slice is unavailable or congested; information that indicates that replacement is desired or requested for a specific UE or a specific set of UEs only; information that indicates an amount of UEs and/or sessions for which the network slice is to be replaced with the alternative network slice; information that indicates whether replacement is desired or requested for only new UE requests or also for already registered UEs and/or established sessions; congestion level of the network slice.

Embodiment 4: The method of embodiment 3 wherein the congestion information comprises the information that indicates whether replacement is desired or requested for only new UE requests or also for already registered UEs and/or established PDU sessions, wherein already registered UEs comprise one or more UEs that are registered with the network slice within one or more established sessions (e.g., PDU sessions) with the network slice and/or one or more UEs that are registered with the network slice but without any established session or without any activated user plane for a session(s) for the network slice.

Embodiment 5: The method of any of embodiments 1 to 4 wherein the sessions are Protocol Data Unit, PDU, sessions.

Embodiment 6: The method of any of embodiments 1 to 5 wherein the determined amount of UEs and/or the determined amount of sessions are a determined amount of new UEs requesting to be registered with the network slice and/or a determined amount of new sessions requested to be established with the network slice.

Embodiment 7: The method of any of embodiments 1 to 5 wherein the determined amount of UEs and/or the determined amount of sessions are a determined amount of existing UEs registered with the network slice and/or a determined amount of existing sessions established on the network slice.

Embodiment 8: The method of any of embodiments 1 to 5 wherein the determined amount of UEs and/or the determined amount of sessions comprise a determined amount of existing and new UEs registered or requesting to be registered with the network slice and/or a determined amount of existing and new sessions established or requested to be established on the network slice.

Embodiment 9: The method of any of embodiments 1 to 8 wherein the determined amount of UEs and/or the determined amount of sessions is/are a function of a congestion level of the network slice.

Embodiment 10: The method of any of embodiments 1-5, 7, or 8 wherein performing or initiating (402) one or more actions to replace the network slice with the alternative network slice for the determined amount of UEs and/or the determined amount of sessions comprises sending (402B), to a Session Management Function, SMF, (208), a request to re-establish one or more sessions of one or more UEs with the alternative network slice.

Embodiment 11: The method of any of embodiments 1 to 10 further comprising: determining (406c) that replacement of the network slice with the alternative network slice is to be stopped; and performing or initiating (408) one or more actions to stop replacement of the network slice with the alternative network slice for one or more UEs and/or one or more sessions (e.g., PDU sessions), responsive to determining (406c) that replacement of the network slice with the alternative network slice is to be stopped.

Embodiment 12: The method of embodiment 11 further comprising receiving (406b), from another network node, information that indicates that replacement of the network slice with the alternative network slice is to be stopped.

Embodiment 13: The method of embodiment 12 wherein the information that indicates that replacement of the network slice with the alternative network slice is to be stopped comprises updated congestion information for the network slice.

Embodiment 14: A network node adapted to perform the method of any of embodiments 1 to 13.

Embodiment 15: A method performed by a network node comprising: sending (400b), to a second network node, congestion information for a network slice, wherein the congestion information is provided with or serves as a trigger for replacement of the network slice with an alternative network slice for an amount of User Equipments, UEs, and/or an amount of sessions due to congestion at the network slice.

Embodiment 16: The method of embodiment 15 wherein the congestion information comprises any one or more of the following: information that indicates whether the network slice is unavailable or congested; information that indicates that replacement is desired or requested for a specific UE or a specific set of UEs only; information that indicates an amount of UEs and/or sessions for which the network slice is to be replaced with the alternative network slice; information that indicates whether replacement is desired or requested for only new UE requests or also for already registered UEs and/or established PDU sessions; congestion level of the network slice.

Embodiment 17: The method of embodiment 16 wherein the congestion information comprises the information that indicates whether replacement is desired or requested for only new UE requests or also for already registered UEs and/or established PDU sessions, wherein already registered UEs comprise one or more UEs that are registered with the network slice within one or more established sessions (e.g., PDU sessions) with the network slice and/or one or more UEs that are registered with the network slice but without any established session or without any activated user plane for a session(s) for the network slice.

Embodiment 18: The method of any of embodiments 15 to 17 wherein the sessions are Protocol Data Unit, PDU, sessions.

Embodiment 19: The method of any of embodiments 15 to 18 wherein the amount of UEs and/or the amount of sessions are an amount of new UEs requesting to be registered with the network slice and/or an amount of new sessions requested to be established with the network slice.

Embodiment 20: The method of any of embodiments 15 to 18 wherein the amount of UEs and/or the amount of sessions are an amount of existing UEs registered with the network slice and/or an amount of existing sessions established on the network slice.

Embodiment 21: The method of any of embodiments 15 to 18 wherein the amount of UEs and/or the amount of sessions comprise an amount of existing and new UEs registered or requesting to be registered with the network slice and/or an amount of existing and new sessions established or requested to be established on the network slice.

Embodiment 22: The method of any of embodiments 15 to 21 wherein the determined amount of UEs and/or the determined amount of sessions is/are a function of a congestion level of the network slice.

Embodiment 23: The method of any of embodiments 15 to 22 wherein the network node is a network node implementing an OAM node, a NSSF, a PCF, or a NWDAF.

Embodiment 24: A network node adapted to perform the method of any of embodiments 15 to 23.

Embodiment 25: A computer program comprising instructions which, when executed on at least one processor, cause the processor to carry out the method according to any of embodiments 1 to 13 or 15 to 23.

Embodiment 26: A carrier containing the computer program of embodiment 25, wherein the carrier is one of an electronic signal, an optical signal, a radio signal, or a computer readable storage medium.

Embodiment 27: A non-transitory computer-readable medium comprising instructions executable by processing circuitry of network node, whereby the network is operable to perform the method of any of embodiments 1 to 13 or any of embodiments 15 to 23.

1. A method performed by a network node, the method comprising:
detecting that a network slice is congested; and
sending, to a second network node, congestion information for the network slice, wherein the congestion information comprises information that indicates that the network slice is to be replaced with an alternative network slice due to congestion, wherein the replacement is to be applied for (a) an amount of User Equipments (UEs), or (b) new UEs registering to the network slice, or for both (a) and (b).

2. The method of claim 1, wherein the congestion information comprises information that indicates that the network slice is congested.

3. (canceled)

4. The method of claim 1, wherein the amount of UEs is a percentage of UEs registered or connected to the network slice.

5. The method of claim 1, wherein the amount of UEs is an amount of new UEs requesting to be registered with the network slice.

6-12. (canceled)

13. The method of claim 1, wherein the second network node is an Access and Mobility Management Function (AMF), and the network node is one of a network node implementing a Network Slice Selection Function (NSSF), a network node implementing an Operations, Administration, and Maintenance (OAM) node, a network node implementing a Policy and Control Function (PCF), or a network node implementing Network Data Analytics Function (NWDAF).

14-16. (canceled)

17. The method of claim 1, wherein sending the congestion information for the network slice comprises sending a Network Slice Availability Notification comprising the congestion information to the second network node.

18. The method of claim 1, further comprising sending, to the second network node, a message to stop replacement of the network slice with the alternative network slice.

19. The method of claim 1, further comprising:
determining that the network slice is no longer congested; and
responsive to determining that the network slice is no longer congested, sending, to the second network node, a trigger to stop replacement of the network slice with the alternative network slice.

20-23. (canceled)

24. A network node comprising processing circuitry configured to cause the network node to:
detect that a network slice is congested; and
send, to a second network node, congestion information for the network slice, wherein the congestion information comprises information that indicates that the network slice is to be replaced with an alternative network slice due to congestion wherein the replacement is to be applied for (a) an amount of User Equipments (UEs), or (b) new UEs registering to the network slice, or for both (a) and (b).

25. The network node of claim 24, wherein the processing circuitry is further configured to cause the network node to send, to the second network node, a message to stop replacement of the network slice with the alternative network slice.

26-28. (canceled)

29. A method performed by an Access and Mobility Management Function (AMF) in a core network of a cellular communications system, the method comprising:
determining that a network slice is to be replaced with an alternative network slice due to congestion in the network slice; and
replacing the network slice with the alternative network slice for (a) a determined amount of User Equipments (UEs) or (b) new UEs registering to the network slice, or for both (a) and (b).

30. The method of claim 29, wherein the replacing step is performed until receiving a notification from another network node to stop the replacement.

31. The method of claim 29, wherein determining that the network slice is to be replaced with the alternative network slice due to congestion in the network slice comprises receiving from another network node a message comprising congestion information indicating the network slice is to be replaced with the alternative network slice due to congestion and the message further comprises (a) the amount of User Equipments (UEs) for which the replacement is to be applied, or (b) that replacement is to be applied for new UEs registering to the network slice.

32. The method of claim 31, wherein the congestion information comprises information that indicates that the network slice is congested.

33-34. (canceled)

35. The method of claim 29, wherein the amount of UEs is a percentage of UEs registered or connected to the network slice.

36.-57. (canceled)

58. The method of claim 1, further comprising including in the congestion information one or more of (a) the amount of UEs for which the replacement is to be applied, or (b) that the replacement is to be applied for new UEs registering to the network slice, or the replacement applies for both (a) and (b).

59. The method of claim 31, wherein the amount of UEs is a percentage of UEs registered or connected to the network slice.
